(19) United States
(12) Patent Application Publication
(10) Pub. No.: US 2017/0054819 A1
(43) Pub. Date: Feb. 23, 2017

(54) SYSTEM AND METHOD TO CATEGORIZE USERS

(71) Applicant: Google Inc., Mountain View, CA (US)

(72) Inventors: David Andrew HUFFAKER, Palo Alto, CA (US); Makoto UCHIDA, Mounlain View, CA (US); Abhijit BOSE, Paramus, NJ (US); Rachel SCHUTT, New York, NY (US); Zachary YESKEL, San Francisco, CA (US)

(21) Appl. No.: 13/917,492

(22) Filed: Jun. 13, 2013

Related U.S. Application Data
(60) Provisional application No. 61/659,381, filed on Jun. 13, 2012.

(51) Int. Cl. G06F 15/16

(52) U.S. Cl. CPC H04L 67/22

(57) ABSTRACT

A system for categorizing users based on activities in a social network analyzes behavior data of online social activities for each user of a set of users. The system generates a user activity log for each user of the set of users, where the user activity log for each user is generated based on the behavior data. The system determines a set of behavioral categories based on the users' activity logs, each behavioral category of the set of behavioral categories being defined by a set of values corresponding to the one or more social activities in the behavior data. The system also associates at least one user of the set of users with one behavioral category of the set of behavioral categories based on the set of values defining the one behavioral category and user activity log for the at least one user.

### CROSS-REFERENCE TO RELATED APPLICATIONS

The present application claims the benefit of priority under 35 U.S.C. §119 from U.S. Provisional Patent Application Ser. No. 61/659,381, filed on Jun. 13, 2012, the disclosure of which is hereby incorporated by reference in its entirety for all purposes.

### TECHNICAL FIELD

The present disclosure generally relates to increasing activity of users on websites and web applications, and, in particular, to improving user experience based on the user's activity.

### BACKGROUND

Internet users utilize the Internet for different purposes and in different manners, and exhibit many different behaviors and preferences. For example, on a social networking application, some users like to post new content, others prefer to react to content that others have posted (e.g., commenting on posted content, reposting content, or showing approval of posted content), and others enjoy consuming content without contributing any additional content. Furthermore, many Internet users may display a combination of these or other activities and may engage in these activities to varying degrees.

### SUMMARY

The disclosed subject matter relates to a method executed on one or more computing devices for categorizing users based on online social activities in a social network, the method comprising analyzing, using the one or more computing devices, behavior data of one or more online social activities for a plurality of users, generating, using the one or more computing devices, user activity log data for the plurality of users, wherein the user activity log data is generated based on the analysis of the behavior data for the plurality of users, determining, using the one or more computing devices, a plurality of behavioral categories based on the activity log data for the plurality of users, each behavioral category of the plurality of behavioral categories being defined by a set of values corresponding to the one or more online social activities in the behavior data, and associating at least one user of the plurality of users with one behavioral category of the plurality of behavioral categories based on the set of values defining the one behavioral category and user activity log data associated with the at least one user.

The disclosed subject matter also relates to a system for categorizing users based on online social activities in a social network, the system comprising one or more processors, and a machine-readable medium comprising instructions stored therein, which when executed by the processors, cause the processors to perform operations comprising analyzing behavior data of one or more online social activities for each a plurality of users, generating user activity log data for the plurality of users, wherein the user activity log data is generated based on the analysis of the behavior data for the plurality of users, determining a plurality of behavioral categories based on the activity log data for the plurality of users, each behavioral category of the plurality of behavioral categories being defined by a set of values corresponding to the one or more online social activities in the behavior data, associating at least one user of the plurality of users with one behavioral category of the plurality of behavioral categories based on the set of values defining the one behavioral category and user activity log data associated with the at least one user, and adjusting social network content associated with each user of the plurality of users based on at least one behavioral category of the plurality of behavioral categories associated with the user.

The disclosed subject matter also relates to a machine-readable medium comprising instructions stored therein, which when executed by a machine, cause the machine to perform operations comprising analyzing behavior data of one or more online social activities for a plurality of users, generating user activity log data for the plurality of users, wherein the user activity log data for is generated based on the analysis of the behavior data for the plurality of users, determining a plurality of behavioral categories based on the activity log data for the plurality of users, each behavioral category of the plurality of behavioral categories being defined by a set of values corresponding to the one or more online social activities in the behavior data, wherein the instructions for determining the plurality of behavioral categories comprise instructions that cause the machine to perform operations comprising generating one or more statistical models corresponding to the one or more social activities using the user activity log data, and associating at least one user of the plurality of users with one behavioral category of the plurality of behavioral categories based on the set of values defining the one behavioral category and user activity log data associated with the at least one user.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example network that can be used to implement some aspects of the subject technology.

FIG. 2 illustrates a flow diagram of an example process 200 for categorizing users in a social network, in accordance with aspects of this disclosure.

FIG. 3 illustrates an example categorization of users in a social network, in accordance with aspects of this disclosure.

FIG. 4 conceptually illustrates an electronic system with which some implementations of the subject technology are implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

I. Overview

Users of the Internet, and specifically users of certain applications and websites, e.g., social networks and applications, have different experiences and ways of interacting with other users and with the different aspects of the social networks or applications and as a result fall into different categories and their experiences are as a result different. Some users post new content, others prefer to react to the content posted by others, and others enjoy consuming content without contributing their own content and/or commenting on the content of others. Therefore, it may be desirable to classify users based on their activity level and to track changes in their activity level over time, adjust their experiences according to their classification, and improve products so that users become more active

In accordance with aspects of this disclosure, a system and method are provided for categorizing users based on detected social activities and behaviors. In one example, the system may utilize an algorithm to categorize the users. The algorithm may utilize statistical modeling to identify different user behaviors, then analyze the distributions associated with each of the different behaviors across all users, and break down the distributions into segments. Part of the analysis may include determining the thresholds in the distributions, e.g., the points in the distributions where states change, e.g., from very active to moderately active, and from moderately active to inactive. Therefore, the algorithm may analyze the users to identify clusters to determine the different behaviors, and then analyze the users within each of the identified clusters to determine the different categorizations into which users fit.

In categorizing users, the system may be able to provide customized user experiences, encourage desired user activities in particular users, design more fitting features for users, and enable system administrators to better understand the users. For example, the system may display and provide more promotional materials and/or different features to users who do not share much or any content such that they may contribute more content and may react more to the content of other users. In another example, the system may analyze users who share a lot of content to determine what makes them share more content than other users and/or may provide them with features that make these users consume more, e.g., react to the content of other users. In one aspect of this disclosure, in addition to categorizing users, the system may track the movement of users among categories, to better understand what influences the behaviors of the users. The system may also determine how users from different categories react to a certain feature.

II. Example Network Environments for Categorizing Users in a Social Network

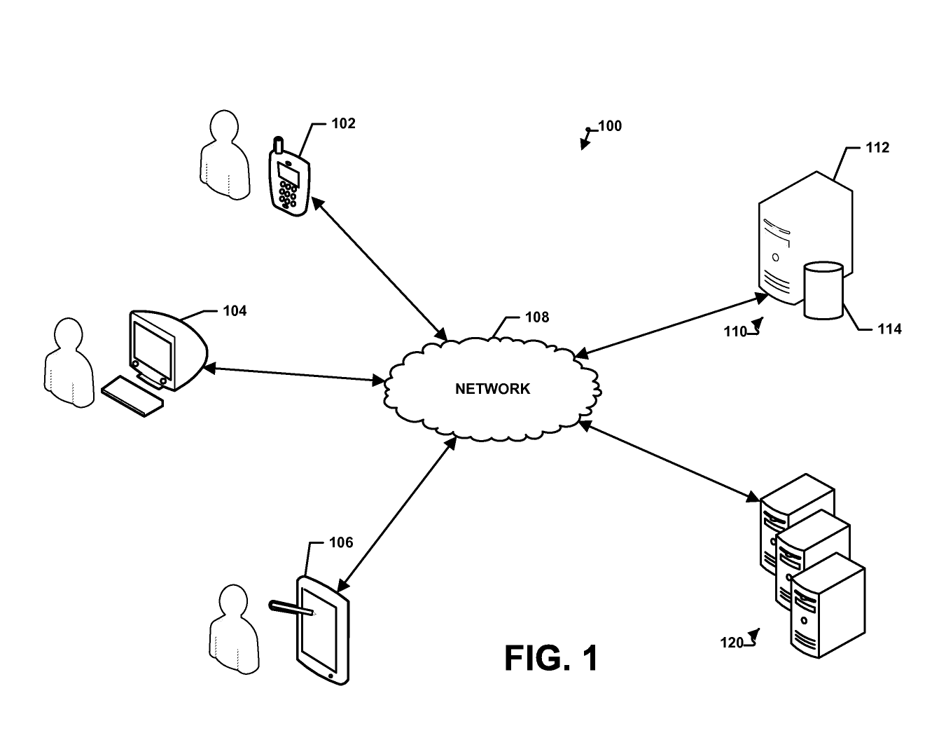

FIG. 1 illustrates an example network that can be used to implement aspects of the subject technology. Specifically, the network system 100 comprises a number of electronic user devices 102, 104 and 106, a network 108, a first server 110 and a second server 120. As illustrated, user devices 102, 104 and 106 are communicatively connected to the first server 110 and the second server 120 via the network 108. Server 110 may include a processing device 112 and a data store 114. Processing device 112 may execute computer instructions stored in data store 114, for example, to categorize users of electronic devices 102, 104 and 106 based on their activities and behaviors in interacting via network 108. It is understood that in addition to the user devices 102, 104, 106, the first server 110 and the second server 120, any number of other processor-based devices could be communicatively connected to the network 108. Furthermore, as will be discussed in greater detail below, the network 108 could comprise multiple networks, such as a network of networks, e.g., the Internet.

In some example embodiments, electronic devices 102, 104 and 106 can be computing devices such as laptop or desktop computers, smartphones, PDAs, portable media players, tablet computers, televisions or other displays with one or more processors coupled thereto or embedded therein, or other appropriate computing devices that can be used to for displaying a web page or web application. In the example of FIG. 1, electronic device 102 is depicted as a smartphone, electronic device 104 is depicted as a desktop computer, and electronic device 106 is depicted as a PDA.

The network 108 may include, for example, any one or more of a personal area network (PAN), a local area network (LAN), a campus area network (CAN), a metropolitan area network (MAN), a wide area network (WAN), a broadband network (BBN), the Internet, and the like. Further, the network 108 may include, but is not limited to, any one or more of the following network topologies, including a bus network, a star network, a ring network, a mesh network, a star-bus network, tree or hierarchical network, and the like.

One or more of the process steps of the subject technology may be carried out by one or more of the user devices 102, 104, 106 and/or the first server 110 and the second server 120. For example, the first server 110 and the second server 120 may be used to support a social network platform accessible by one or more users (e.g., via user devices 102, 104 and 106). Additionally, in some aspects, the first server 110 and/or the second server 120 may be used to obtain, store, and process information associated with users connected to the social network and the activities and behaviors of the users in their interaction with the social network to categorize the users based on their social activities and behaviors, as discussed in more detail below.

In one example, the subject technology may comprise a system for categorizing users based on users' activities in a network (e.g., a social network). The system may be hosted at server 110, for example, and may include an input processor, a data processor, and an output processor. The input processor may be configured to obtain behavior data for a number of users and generate user activity logs for the users. For example, the input processor may detect a user's activities on a social networking application (e.g., an online community) over a period of time and generate a user activity log based on detected activities and the time each activity occurred (e.g., a timestamp). The input processor can generate activity logs on a per user basis where an activity log is generated for each user or can generate activity logs that include aggregate data for multiple users.

The data processor may be configured to create a number of categories based on the activities listed in the user activity logs and classify the users into at least one of the created categories. In one example, the data processor may generate the categories using a clustering algorithm (e.g., a K-means clustering algorithm), which may divide a set of observations (e.g., the user activity logs) into subsets or clusters (e.g., categories) so that the observations in each cluster are similar in some sense.

The output processor may be configured to create an output illustrating the categorization of users and provide statistics and characteristics of the users and their activities. This output information may be utilized to customize user experiences or provide features more appropriate for users based on their activities. In one example, the output information may be provided to system administrators of the network or networking application in which the users interact with other users and with the network or application.

The operations associated with the input processor, data processor, and output processor may be implemented by one or more processors (e.g., processing device 112), which may be operable to execute to one or more algorithms, e.g., a categorizing algorithm. In one example, the categorizing algorithm may categorize users based on users' activities in the network. The categorizing algorithm may comprise one or more algorithms, which may perform one or more of the operations associated with the present disclosure.

III. Example Processes for Categorizing Users in a Social Network

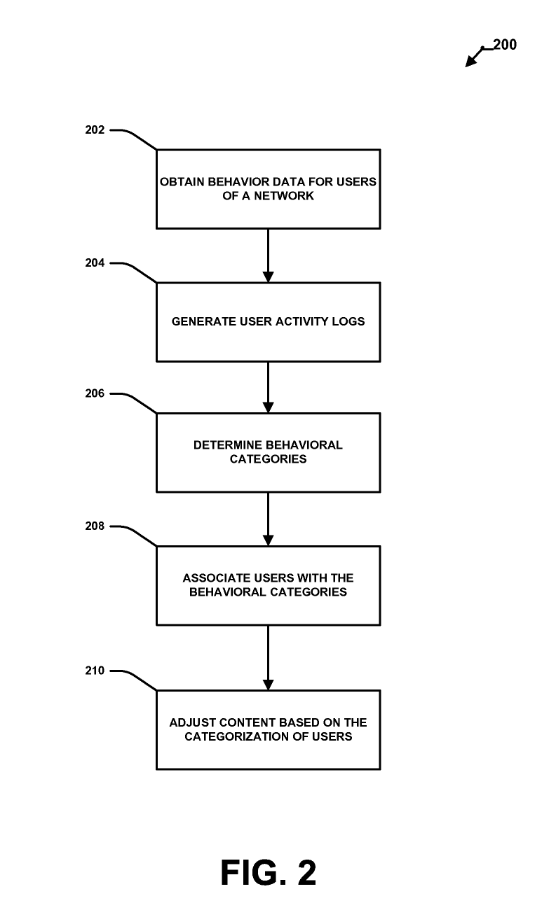

FIG. 2 illustrates a flow diagram of an example process 200 for categorizing users in a social network, in accordance with aspects of this disclosure. Example process 200 may be performed by a computing device, e.g., server 110 of FIG. 1. In some examples, a computer-readable storage medium (e.g., data store 114) may be encoded with instructions that, when executed, cause one or more processors (e.g., processing device 112) to perform one or more of the acts illustrated in example process 200.

The present disclosure provides a method for categorizing users in a network (e.g., a social network) based on users' social activities. The activities may include any detectable action associated with a user in his or her interaction with other users or with features of the network. Activities may include, among other thing, posting content in a published information stream, posting content of a particular type (e.g., an image, a link, a file, etc.) in the information stream, commenting on posted content, reposting content posted by another user, indicating approval of posted content, receiving comments or approval from other users, reading posted content (e.g., scrolling a user interface containing the information stream), signing in to a social networking application, sending messages to users, reading or receiving messages from users, etc.

The process for categorizing users based on users' activities in a network may include input processing, data processing, and output processing. In some examples, input processing includes obtaining and analyzing behavior data for a plurality of users in the network (202). In one example, behavior data may correspond to one or more social activities of the users in the network. Input processing also includes generating user activity logs for the users (204). In one example, obtaining the behavior data may include extracting data from user logs or taking existing raw data. The data may be collected over a period of time and may have associated time and date, which may be utilized generating the user activity logs. Generating the user activity logs may include transforming each user activity log (e.g., data of a user's activity over time) into a structured file, which may include, for example, instances of incoming and outgoing information sharing and the corresponding timestamp (e.g., time and date). In one illustrative example in the context of a social networking application, input processing may, for example, track the posting, reading, commenting, and approval indications of a number of users of a social networking application for a period of time (e.g., 7 days) and generate a user behavior log with these behaviors for each user.

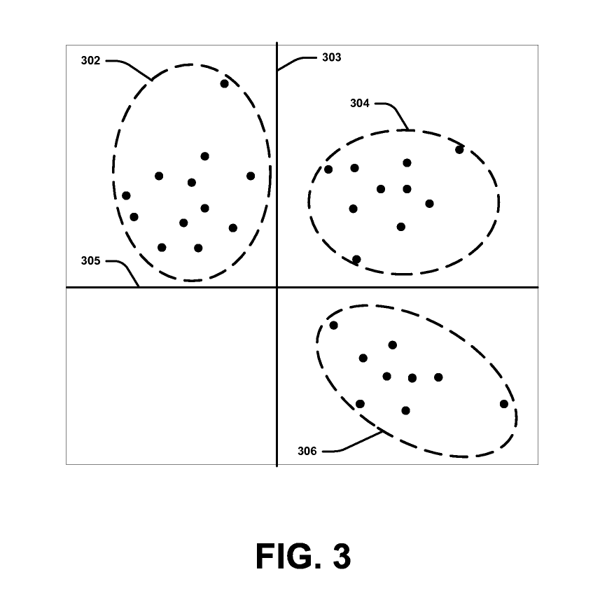

Data processing includes determining a plurality of behavioral categories based the users' activity logs for the plurality of users in the network (206). In one example, each behavioral category may be defined by a set of values corresponding to the one or more social activities in the user activity logs. In some examples, other user data (e.g., user profiles) may be also evaluated to determine the behavioral categories. In one example, data processing may utilize statistical evaluations to generate the behavioral categories. For example, a clustering algorithm (e.g., a K-means clustering algorithm) may be utilized to divide a set of observations (e.g., the user activity logs) into subsets or clusters (e.g., categories) so that the observations in each cluster are similar in some sense, as illustrated in the example of FIG. 3.

FIG. 3 illustrates an example categorization of users in a social network, in accordance with aspects of this disclosure. As FIG. 3 shows, for a certain online activity, activity log data of users of the social network may be defined by a set of values. The values corresponding to each of the users is plotted and a clustering algorithm is used to generate one or more clusters, e.g., clusters 302, 304, and 306. In this manner, users who exhibit similar behaviors within a specific online activity get clustered together, thus defining a behavioral category associated with the corresponding online activity. In one example, the users of the social network get divided into two clusters corresponding to two behavioral categories associated with the online activity. In this example, a threshold value is determined as a dividing point between the two categories, where a user is associated with the first behavioral category if the value associated with the user for the corresponding online activity falls below the threshold value, and associated with the second behavioral category if the value associated with the user for the corresponding online activity is equal to or greater than the threshold value.

In other examples, as illustrated in FIG. 3, the users of the social network get divided into more than two clusters corresponding to more than two behavioral categories associated with the online activity. In this example, the values representing the online activity are divided into three categories based on the clustering behavior of the values. Based on these clusters 302, 304, and 306, behavior categories are determined for the associated online activity, and the behavior categories are defined by threshold values 303 and 305. Subsequent analysis of user behavior for the corresponding online activity results in categorizing the user's activity into one of the behavioral categories relative to threshold values 253 and 255.

The statistical evaluation may evaluate the behavior characteristics and frequency of the behavior, then draw the lines that define the thresholds for each behavior to identify two or more categories (or clusters) of similar users, e.g., very active commenter or power user and moderate commenter or ordinary user. Generating behavioral categories may also depend on user-defined thresholds, in addition to the statistical evaluation. For example, users who have more than a certain number of shares in a social network may be identified as power users.

In the context of a social networking application, a user's profile on the social network may be evaluated, along with sharing behavior to determine several attributes of the user. The user profile information may include, for example, the amount of information a user has filled on his or her profile and the audience (e.g., the public, a personal network, or an extended network) to which the user makes the profile information available. The profile data may also include any of the data listed in the user's profile as well as the user's settings for the social networking application. Other information that may be evaluated in this illustrative example, may be the amount of online sharing that occurs during a time period (e.g., posts, media types, comments, adding friends, and the like). The content of the sharing (e.g., media type, text length, etc.) and amount of incoming feedback (e.g., comments that a user receives) may also be considered in the evaluation.

In one example, the statistical evaluation may also include determining whether the data distributions are appropriate (e.g., skewed, uniform, long-tailed, etc.) and the relationship between the individual variables. This information regarding the distributions may be utilized in evaluating the output during output processing, described below.

Referring again to FIG. 2, data processing also includes associating each of the users with at least one of the determined behavioral categories (208). The association of a user with a behavioral category may be based on the set of values defining the one behavioral category and the user's activity log. In this manner, each user may be classified into at least one of the behavioral categories.

Output processing includes adjusting the content of the network utilizing the categorization information (210). Adjusting the content may include, for example, utilizing the categorization information to customize content for each user based on the category to which the user is assigned. For example, the system may present messages that encourage certain activities (e.g., posting or commenting) to users in a category associated with low activity or, for a user in a category associated with high activity of a certain type (e.g., posts or reposts), the system may present rank content in a user's information stream differently to encourage the user to share or repost certain content.

In some examples, output processing may also include creating a visualization of the categorization of users and providing system administrators with statistics and characteristics of the users of the network. Using this information, system administrators may be able to develop more customized user experiences or design more appropriate features for users, for example. In some examples, visualization and tracking of user behavior may be done relatively in real-time, thus providing feedback and adjustments while the users may be online, for example.

In some aspects, the system may also have access to user profiles and activities in other applications as well (e.g., an email application, an online media-sharing application, a content (e.g., news) delivery application, a search application, a mapping application, etc.). Additional measures may be taken to restrict access to user identity or other sensitive information in order to protect the users' privacy. Activities and behavior on these applications may also be monitored by the system and used to categorize users.

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

IV. Example Systems for Organizing Users in a Social Network

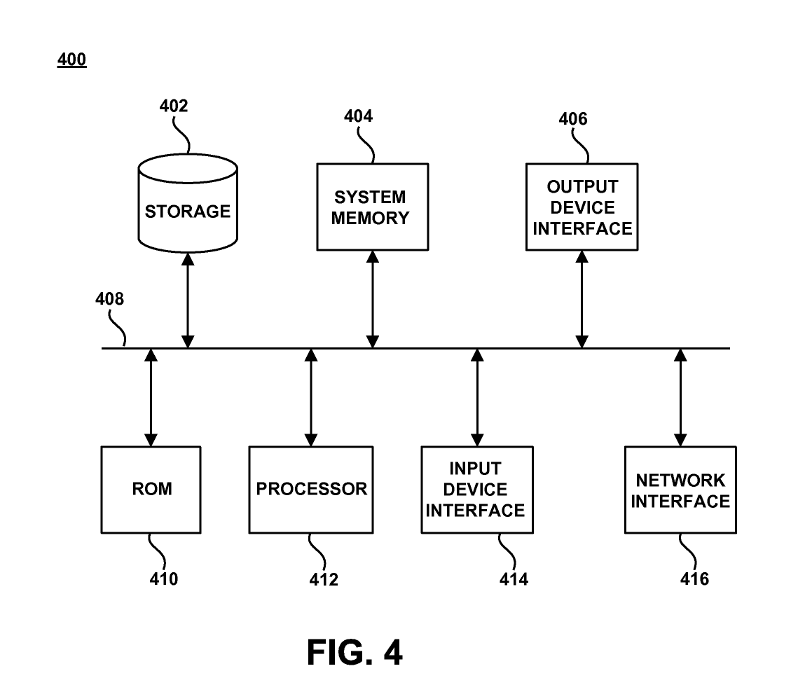

FIG. 4 conceptually illustrates an electronic system with which some implementations of the subject technology are implemented. Electronic system 400 can be a server, computer, phone, PDA, laptop, tablet computer, television with one or more processors embedded therein or coupled thereto, or any other sort of electronic device. Such an electronic system includes various types of computer readable media and interfaces for various other types of computer readable media. Electronic system 400 includes a bus 408, processing unit(s) 412, a system memory 404, a read-only memory (ROM) 410, a permanent storage device 402, an input device interface 414, an output device interface 406, and a network interface 416.

Bus 408 collectively represents all system, peripheral, and chipset buses that communicatively connect the numerous internal devices of electronic system 400. For instance, bus 408 communicatively connects processing unit(s) 412 with ROM 410, system memory 404, permanent storage device 402.

From these various memory units, processing unit(s) 412 retrieves instructions to execute and data to process in order to execute the processes of the subject disclosure. The processing unit(s) can be a single processor or a multi-core processor in different implementations.

ROM 410 stores static data and instructions that are needed by processing unit(s) 412 and other modules of the electronic system. Permanent storage device 402, on the other hand, is a read-and-write memory device. This device is a non-volatile memory unit that stores instructions and data even when electronic system 400 is off Some implementations of the subject disclosure use a mass-storage device (such as a magnetic or optical disk and its corresponding disk drive) as permanent storage device 402.

Other implementations use a removable storage device (such as a floppy disk, flash drive, and its corresponding disk drive) as permanent storage device 402. Like permanent storage device 402, system memory 404 is a read-and-write memory device. However, unlike storage device 402, system memory 404 is a volatile read-and-write memory, such a random access memory. System memory 404 stores some of the instructions and data that the processor needs at runtime. In some implementations, the processes of the subject disclosure are stored in system memory 404, permanent storage device 402, and/or ROM 410. For example, the various memory units include instructions for categorizing users in a social network according to various embodiments. From these various memory units, processing unit(s) 412 retrieves instructions to execute and data to process in order to execute the processes of some implementations.

Bus 408 also connects to input and output device interfaces 414 and 406. Input device interface 414 enables the user to communicate information and select commands to the electronic system. Input devices used with input device interface 414 include, for example, alphanumeric keyboards and pointing devices (also called “cursor control devices”). Output device interfaces 406 enables, for example, the display of images generated by the electronic system 400. Output devices used with output device interface 406 include, for example, printers and display devices, such as cathode ray tubes (CRT) or liquid crystal displays (LCD). Some implementations include devices such as a touchscreen that functions as both input and output devices.

Finally, as shown in FIG. 4, bus 408 also couples electronic system 400 to a network (not shown) through a network interface 416. In this manner, the computer can be a part of a network of computers (such as a local area network (“LAN”), a wide area network (“WAN”), or an Intranet, or a network of networks, such as the Internet. Any or all components of electronic system 500 can be used in conjunction with the subject disclosure.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of exemplary approaches. Based upon design preferences, it is understood that the specific order or hierarchy of steps in the processes may be rearranged, or that some illustrated steps may not be performed. Some of the steps may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure. Features under one heading may be combined with features under one or more other heading and all features under one heading need not be use together. Features under one heading may be combined with features under one or more other heading and all features under one heading need not be use together.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A method executed on one or more computing devices for categorizing users based on online social activities in a social network, the method comprising:
processing, by one or more computing devices, behavior data corresponding to one or more online social activities of a plurality of users;
generating, by the one or more computing devices, user activity log data for each user of the plurality of users, wherein the user activity log data is generated based on the processed behavior data for the plurality of users;
associating the user activity log data of each user of the plurality of users to a value of a plurality of values associated with a particular online social activity of the one or more online social activities;
determining, by the one or more computing devices, a plurality of behavioral categories based on the value associated with the user activity log data of each user of the plurality of users for the particular online social activity, each of the plurality of behavioral categories being defined by a respective set of values in the plurality of values associated with the particular online social activity;
associating at least one user of the plurality of users with at least one behavioral category of the plurality of behavioral categories based on the respective set of values defining the at least one behavioral category and the user activity log data associated with the at least one user and
adjusting social network content presented to the at least one user based on the associated at least one behavioral category in order to encourage the at least one user to interact differently with the social network.

2. (canceled)

3. The method of claim 1, wherein adjusting the social network content comprises customizing features available within the social network to the user.

4. The method of claim 1, further comprising providing the plurality of behavioral categories for display.

5. The method of claim 1, wherein the one or more online social activities for a user comprise interactions between the user and other users of the plurality of users.

6. The method of claim 1, wherein the one or more online social activities for a user comprise content contributed by the user to the social network.

7. The method of claim 6, wherein the one or more online social activities for the user comprise reactions by other users of the plurality of users to the content contributed by the user to the social network.

8. The method of claim 1, wherein the one or more online social activities for a user comprise attributes associated with a profile of the user on the social network.

9. The method of claim 1, wherein determining the plurality of behavioral categories comprises:
generating one or more statistical models corresponding to the one or more social activities using the user activity log data; and
determining at least one threshold within each of the one or more statistical models to determine at least a first and second behavioral categories associated with each of the one or more online social activities, wherein the first behavioral category corresponds to online social activities below the at least one threshold and the second behavioral category corresponds to online social activities equal to or above the at least one threshold.

10. The method of claim 9, wherein generating the one or more statistical models comprises utilizing a clustering algorithm to determine two or more clusters of users for each of the one or more online social activities.

11. (canceled)

12. The method of claim 1, wherein generating user activity log data for the plurality of users comprises generating user activity log data for a set of multiple users of the plurality of users.

13. A system for categorizing users based on online social activities in a social network, the system comprising:
one or more processors; and
a non-transitory machine-readable medium comprising instructions stored therein, which when executed by the processors, cause the processors to perform operations comprising:
analyzing behavior data corresponding to one or more online social activities of each user of a plurality of users;
generating user activity log data for each user of the plurality of users, wherein the user activity log data is generated based on the analysis of the behavior data for the plurality of users;
associating the user activity log data of each user of the plurality of users to a value of a plurality of values associated with a particular online social activity of the one or more online social activities;
determining a plurality of behavioral categories based on the value associated with the user activity log data of each user of the plurality of users for the particular online social activity, each of the plurality of behavioral categories being defined by a respective set of values in the plurality of values associated with the particular online social activity;
associating at least one user of the plurality of users with at least one behavioral category of the plurality of behavioral categories based on the respective set of values defining the at least one behavioral category and the user activity log data associated with the at least one user; and
adjusting social network content presented to the at least one user based on the associated at least one behavioral category in order to encourage the at least one user to interact differently with the social network.

14. The system of claim 13, wherein the instructions for determining the plurality of behavioral categories comprise instructions that cause the processors to perform operations comprising:
generating one or more statistical models corresponding to the one or more social activities using the user activity log data; and
determining at least one threshold within each of the one or more statistical models to determine at least a first and second behavioral categories associated with each of the one or more online social activities, wherein the first behavioral category corresponds to online social activities below the at least one threshold and the second behavioral category corresponds to online social activities equal to or above the at least one threshold.

15. The system of claim 14, wherein the instructions for generating the one or more statistical models comprise instructions that cause the processors to perform operations comprising utilizing a clustering algorithm to determine two or more clusters of users for each of the one or more online social activities.

16. The system of claim 13, wherein the instructions for adjusting the social network content comprise instructions that cause the processors to perform operations comprising customizing features available within the social network to the user.

17. A non-transitory machine-readable medium comprising instructions stored therein, which when executed by a machine, cause the machine to perform operations comprising:
analyzing behavior data corresponding to one or more online social activities of a plurality of users;
generating user activity log data for each user of the plurality of users, wherein the user activity log data for is generated based on the analysis of the behavior data for the plurality of users;
associating the user activity log data of each user of the plurality of users to a value of a plurality of values associated with a particular online social activity of the one or more online social activities;
determining a plurality of behavioral categories based on the value associated with the user activity log data of each user of the plurality of users for the particular online social activity, each of the plurality of behavioral categories being defined by a respective set of values in the plurality of values associated with the particular online social activity;
generating one or more statistical models corresponding to the particular online social activity using the user activity log data of each user of the plurality of users for the particular online social activity;
associating at least one user of the plurality of users with at least one behavioral category of the plurality of behavioral categories based on the respective set of values defining the at least one behavioral category and user activity log data associated with the at least one user; and
adjusting social network content presented to the at least one user based on the associated at least one behavioral category in order to encourage the at least one user to interact differently with the social network.

18. The non-transitory machine-readable medium of claim 17, wherein the instructions for determining the plurality of behavioral categories further comprise instructions that cause the machine to perform operations comprising determining at least one threshold within each of the one or more statistical models to determine at least a first and second behavioral categories associated with each of the one or more online social activities, wherein the first behavioral category corresponds to online social activities below the at least one threshold and the second behavioral category corresponds to online social activities equal to or above the at least one threshold.

19. The non-transitory machine-readable medium of claim 17, wherein the instructions for generating the one or more statistical models comprise instructions that cause the machine to perform operations comprising utilizing a clustering algorithm to determine two or more clusters of users for each of the one or more online social activities.

20. (canceled)

21. The method of claim 1, further comprising:
obtaining, by the one or more computing devices, user logs for a plurality of users in a network, the user logs indicating the one or more online social activities of the plurality of users over a period of time; and
extracting, by the one or more computing devices, raw data including associated timestamps from the user logs for obtaining the behavior data.

22. The method of claim 1, wherein each of the respective sets of values identifies a different cluster of users from the plurality of users that corresponds to a different number of user interactions with respect to the particular online social activity.
